(19) United States
(12) Patent Application Publication
(10) Pub. No.: US 2013/0208499 A1
(43) Pub. Date: Aug. 15, 2013

(54) ILLUMINATED KEYBOARD PROVIDING HIGH AND UNIFORM LUMINOSITY

(71) Applicants: Chin-Wen CHOU, New Taipei City (TW); Chin-Hsiu Hwa, New Taipei City (TW); Yu-Chun Huang, New Taipei City (TW)

(72) Inventors: Chin-Wen CHOU, New Taipei City (TW); Chin-Hsiu Hwa, New Taipei City (TW); Yu-Chun Huang, New Taipei City (TW)

(21) Appl. No.: 13/372,028

(22) Filed: Feb. 13, 2012

(51) Int. Cl. G09F 13/04

(52) U.S. Cl. 362/602

(57) ABSTRACT

An illuminated keyboard providing high and uniform luminosity includes a keyboard portion and at least one light guide element. The keyboard portion includes a plurality of key units and a substrate to hold the key units. The key units are arranged in parallel rows each having multiple key units to form a key unit assembly. The key unit assembly is spaced from the substrate to form a vertical projection space, and any two neighboring key unit assemblies form a horizontal mounting space. The light guide element includes a light guide portion located in the horizontal mounting space and two light projecting portions located in the vertical projection space. Each light projecting portion has at least one transparent zone to project light transmitted by the light guide portion into the vertical projection space to provide uniform luminosity for the key unit assembly.

### FIELD OF THE INVENTION

The present invention relates to an illuminated keyboard and particularly to an illuminated keyboard to provide high and uniform luminosity.

### BACKGROUND OF THE INVENTION

Keyboard is a command output device of a computer system. Its design mainly aims to allow users to comfortably and accurately enter command signals. In a dim environment, the users who are not familiar with the symbols or characters on the keycaps cannot enter the command signals quickly. In order to help the users to recognize more clearly the legends on the keycaps in the dim environment, illuminated keyboards have been developed to meet such purpose.

Some conventional illuminated keyboards adopt a light guide plate as a lighting element, such as U.S. Pat. Nos. 6,648,530, 6,860,612 and 7,531,764, and R.O.C. patent Nos. 509955, 516671, 587800 and 594546. They mainly use a light emitting back panel such as an electroluminescent sheet, optical fiber panel or the like to replace a great number of LEDs. The illuminated keyboard thus formed can generate uniform illumination through a single light emitting panel, hence requires fewer elements and can save production and assembly processes and costs.

Aside from the aforesaid light guide plate, some other keyboards use a light guide strip as a light emitting element, such as R.O.C. publication No. 201115609. It mainly includes a keyboard portion and a light guide portion. The keyboard portion includes a plurality of keycaps, a substrate to hold the keycaps and a movement space between the keycaps and substrate. The light guide portion includes at least one opaque zone and one transparent zone. The transparent zone projects light to the keyboard portion at a preset angle.

In the previous example, the light guide portion is located between the keycaps and substrate, and provides the movement space for the keycaps to move reciprocally up and down, thus the existing space in the conventional keyboard can be fully used to achieve light emitting elect. Compared with the illuminated keyboard with the light guide plate as the light emitting element, such a structure is thinner and lighter. However, it also has drawbacks, such as the light guide strip is too thin and located between a plurality of key unit assemblies that are arranged in multiple rows. Thus the transparent zone on the surface of the light guide strip is not located beneath the key unit assemblies. When the transparent zone projects light at the preset angle to the key unit assemblies, a portion of light would be lost outside the key unit assemblies and results in insufficient luminosity of the keyboard.

To resolve the aforesaid problem, China patent No. CN201681747 discloses a technique that the light guide strip has a plurality of branches extended beneath the key units to directly project light to the key units. However, with each branch corresponding to only one key unit, the number of the branches extended from the light guide strip has to be provided the same as the number of the key units. Fabrication process and cost of the light guide strip increase significantly. On the other hand, as the light projected to the key unit comes from a corresponding branch, and different branches have varying light emission efficiency due to fabrication process variations. As a result, the luminosity of the key units could possibly be different.

### SUMMARY OF THE INVENTION

The primary object of the present invention is to solve the problem of the conventional technique that adopts an elongate and thin light guide strip and cannot evenly project light to the key units.

To achieve the foregoing object, the present invention provides an illuminated keyboard that provides high and uniform luminosity. The illuminated keyboard includes a keyboard portion and at least one light guide element. The keyboard portion includes a plurality of key units and a substrate to hold the key units for performing trigger movement. The key units are arranged in parallel rows each having multiple key units to form a key unit assembly. The key unit assembly is spaced from the substrate to form a vertical projection space and any two neighboring key unit assemblies form a horizontal mounting space. The light guide element is located on the substrate and between any two neighboring key unit assemblies, and includes a light guide portion located in the horizontal mounting space and two light projecting portions located in the vertical projection space. Each light projecting portion has at least one transparent zone to project light to the key unit assembly. Light transmitted by the light guide portion is projected via the transparent zone into the vertical projection space to provide uniform luminosity for the key unit assembly.

In one embodiment of the invention the light guide element includes an opaque zone on the surface of the light projecting portion outside the transparent zone.

In another embodiment the transparent zone includes at least one light emitting groove corresponding to the key unit, and the light transmitted by the light guide element is condensed by the light emitting groove and projected to the key unit.

In yet another embodiment the light emitting groove is formed at a depth gradually increasing from a location proximate to an external light source to a location remote from the external light source.

In yet another embodiment the light emitting groove is formed in a cross section with a polygonal, semicircular or irregular shape.

In yet another embodiment each key unit includes a keycap, a driven mechanism located between the keycap and substrate, and an elastic element located in the driven mechanism. The elastic element provides a returning force for the keycap so that the key unit can perform the trigger movement against the substrate.

In yet another embodiment the substrate includes at least one holding portion to hold the driven mechanism.

In yet another embodiment the keyboard portion includes a circuit board located between the substrate and keycap to generate an output command during the trigger movement of the keycap.

In yet another embodiment the circuit board is located above the substrate.

In yet another embodiment the circuit board is located below the substrate and a baseboard is provided below the circuit board.

In yet another embodiment the light guide element is located on the circuit board or substrate.

In yet another embodiment the light guide element includes at least one end thereof to receive the light from the external light source and guide the light into the light guide element.

In yet, another embodiment the external light source is located on the substrate and can be an electroluminescent element or a light emitting diode.

By means of the structure set forth above, compared with the conventional techniques, the keyboard of the invention provides many advantages, notably:

1. The light guide element provides a greater light emission area. With the multiple key units arranged in parallel rows forming multiple key unit assemblies, and a vertical projection space formed between each key unit assembly and substrate and two light projecting portions provided by the light guide element in the vertical projection space, the light can be directly projected through the transparent zone of the light projecting portion to the key unit assembly to provide uniform luminosity for the key unit assembly.

2. With the transparent zone of the light projecting portion having multiple light emitting grooves corresponding to the key units, the light can be condensed and projected to the key units so that the key unit assembly has uniform and intensified luminosity.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the illuminated keyboard of the invention.

FIG. 2 is a cross section taken on line A-A in FIG. 1 according to a first embodiment of the invention.

FIG. 3 is a cross section taken on line B-B in FIG. 1 according to the first embodiment of the invention.

FIG. 4 is a cross section taken on line B-B in FIG. 1 according to a second embodiment of the invention.

FIG. 5 is a fragmentary enlarged view of the light guide element according to a third embodiment of the invention.

FIG. 6 is a fragmentary enlarged view showing the light emitting groove formed at a depth gradually increasing from a location proximate to the external light source to a location remote from the external light source.

FIG. 7 is a cross section taken on line A-A in FIG. 1 according to a fourth embodiment of the invention.

### DETAILED DESCRIPTION OF THE PREFERRED EMBODIMENTS

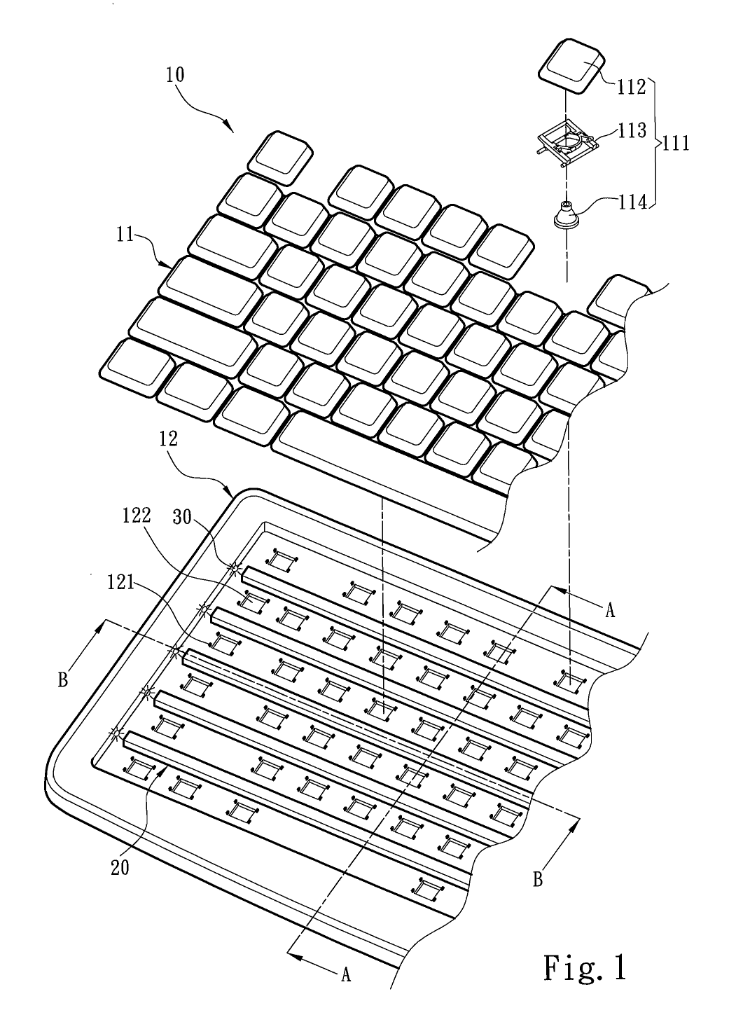

Please refer to FIG. 1, the present invention aims to provide an illuminated keyboard with high and uniform luminosity. The illuminated keyboard mainly includes a keyboard portion 10 and at least one light guide element 20. The keyboard portion 10 includes a plurality of key units 111 and a substrate 12 to hold the key units 111 for performing trigger movement. The key units 111 are arranged in parallel rows each having multiple key units 111 to form a key unit assembly 11.

Each key unit 111 includes a keycap 112 with a symbol or character marked thereon, a driven mechanism 113 bridging the keycap 112 and substrate 12, and an elastic element 114 located in the driven mechanism 113. To facilitate holding of the key units 111 on the substrate 12 without loosening off, the substrate 12 has a plurality of holding portions 121 to hold the driven mechanisms 113.

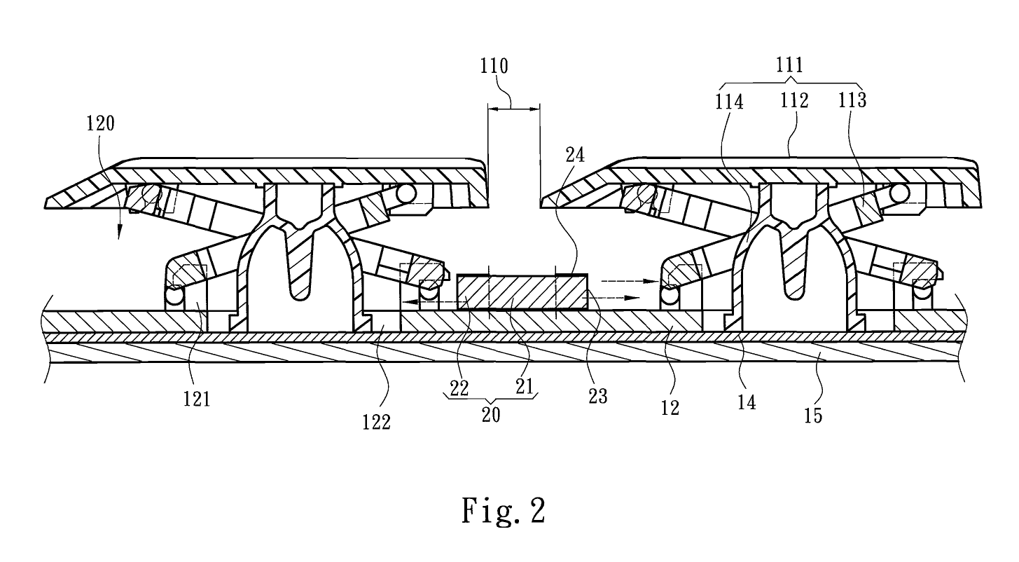

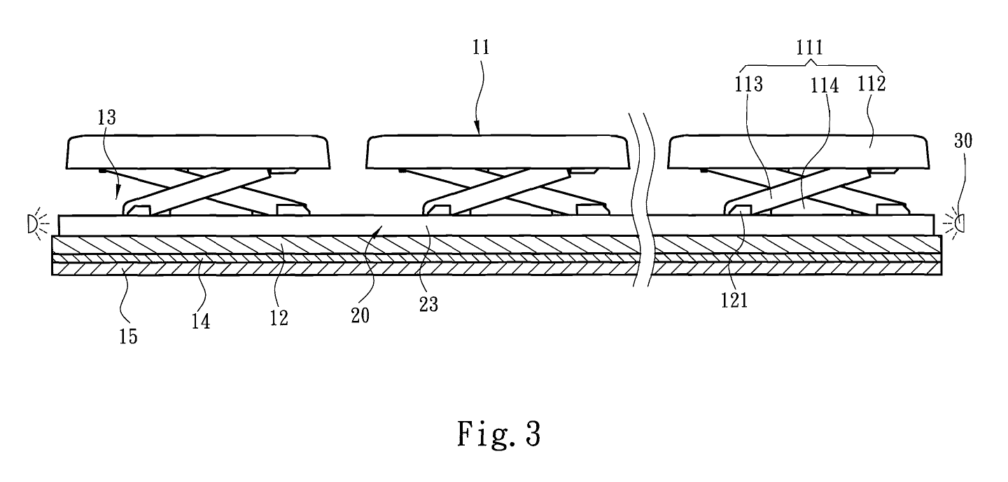

Also referring to FIGS. 2 and 3, when in use a user's finger tip pushes the keycap 112, the elastic element 114 is pressed to pass through an opening 122 formed on the substrate 12 to connect to a circuit board 14 (referring to FIG. 2) below the substrate 12 to generate an output command. When the elastic element 114 is pressed, a returning force in the direction opposite to the pressing direction is generated to allow the keycap 112 to return to the original position before not being pressed by the finger tip. In an embodiment of the invention, the keyboard portion 10 includes a baseboard 15, a circuit board 14 located on the baseboard 15 and a substrate 12 located on the circuit board 14. The light guide element 20 is located on the substrate 12 and between any two neighboring key unit assemblies 11. The light guide element 20 can be an optical fiber or any light transmission object. The light guide element 20 has at least one end to receive the light from an external light source 30 and to guide light into the light guide element 20. The external light source 30 can be located on the substrate 12, but this is not the limitation of the invention. The external light source 30 can be an electroluminescent element, LED or any other lighting element. In other embodiments, the light guide element 20 may also emit light by getting external electric power, such that the external light source 30 can be omitted.

To facilitate discussion of the features of the invention, the area between each key unit assembly 11 and substrate 12 is defined as a vertical projection space 120, and the area between any two neighboring key unit assemblies 11 is defined as a horizontal mounting space 110. The light guide element 20 includes a light guide portion 21 located in the horizontal mounting space 110 and two light projecting portions 22 located in the vertical projection space 120. Each light projecting portion 22 has at least one transparent zone 23 to project light to the key unit assembly 11 and an opaque zone 24 on the surface thereof outside the transparent zone 23.

The transparent zone 23 is located in the vertical projection space 120. Light transmitted by the light guide portion 21 directly projects through the transparent zone 23 into the vertical projection space 120, hence light lost outside the key unit 111 is reduced, and the key unit assembly 11 has uniform luminosity. The opaque zone 24 can be formed by coating a light absorbing or reflecting layer to prevent the light transmitted from the light guide portion 21 from passing through. In addition, the driven mechanism 113 and elastic element 114 also can be made from light transmission material. The surface of the substrate 12 can also be coated with a light reflection material. Hence light can be absorbed by the driven mechanism 113 and elastic element 114 held in the vertical projection space 120 and transmitted to the keycap 112. The substrate 12 also can reflect the light to the keycap 112 to further increase the luminosity of the keycap 112.

Please refer to FIGS. 1 through 3 for a first embodiment of the light guide element 20 of the invention. It is an elongate square body with the transparent zone 23 located on a lateral surface of the light projecting portion 22, but this is not the limitation of the invention. For instance, the transparent zone 23 can also be located on the upper surface of the light projecting portion 22 in the vertical projection space 120, i.e., the location of the transparent zone 23 is changeable according to user's preference to condense and project the light to a selected location of the key unit assembly 11. In the first embodiment, the transparent zone 23 is located on the lateral surface of the light projecting portion 20 so that the light can be directly projected to a plurality of driven mechanisms 112 and elastic elements 114. In the event that the transparent zone 23 is located on an upper surface of the light projecting portion 20, the light can be directly projected to a plurality of keycaps 112, hence lighting effect of the illuminated keyboard can be changed according to different requirements.

As a whole, the transparent zone 23 corresponds to the key unit assembly 11. Hence when two cross section ends of the light guide element 20 receive incident light from the light source, the light transmitted by the light guide portion 21 projects into the vertical projection space 120 through the transparent zone 23. As the transparent zone 23 corresponds to an entire row of the key unit assembly 11, the key units 111 of the keyboard portion 10 can have uniform luminosity.

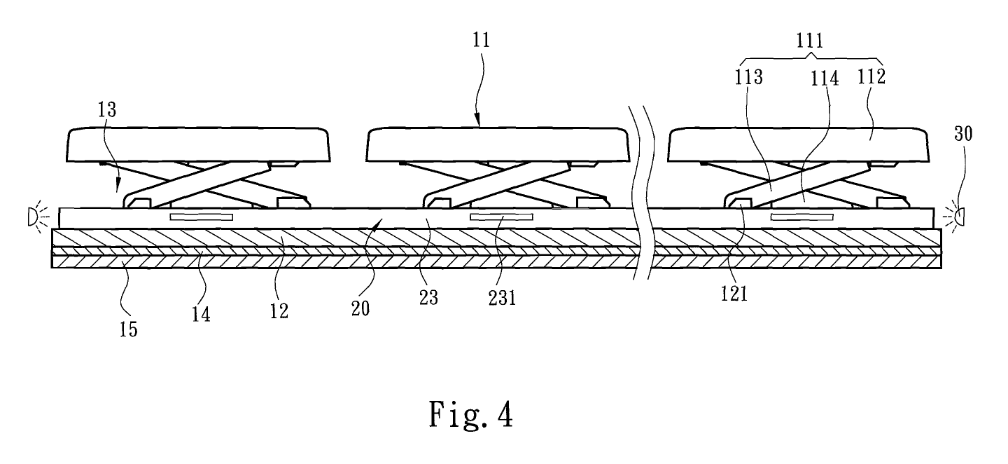

Please refer to FIG. 4 for a second embodiment. The transparent zone 23 of the light guide element 20 includes at least one light emitting groove 231 corresponding to the key units 111. The light emitting groove 231 has an inner wall to condense light and project the light outwards. The light projecting direction of the light emitting groove 231 can be changed by altering the three dimensional profile thereof without being restricted by the three dimensional structure of the light projecting portion 22.

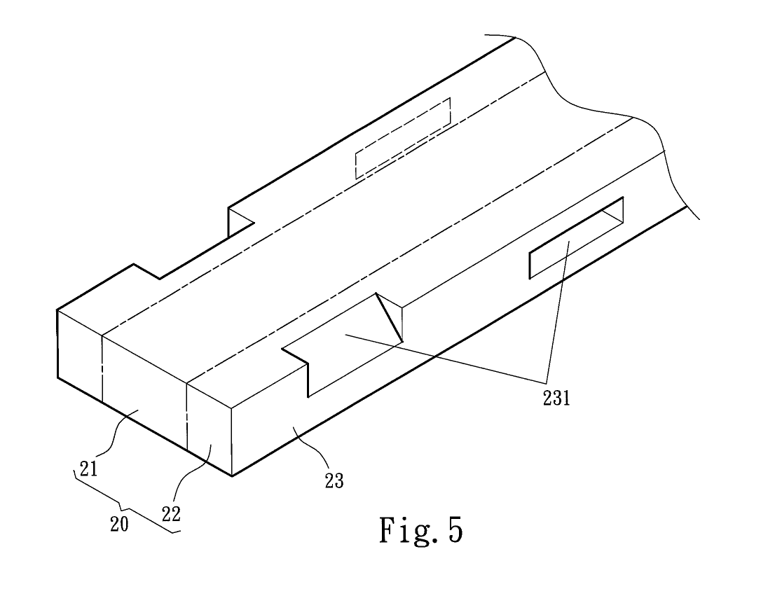

Please refer to FIG. 5 for a third embodiment of the light guide element. The transparent zone 23 includes two types of light emitting grooves 231, one has a triangular cross section and another has a rectangular cross section that are perpendicular to the extending direction of the light guide element 21 and formed at different locations on the light projecting portion 22. The light emitting groove 231 with the triangular cross section is located at one edge of the light projecting portion 22 to project the light upward in an inclined manner, while another light emitting groove 231 with the rectangular cross section is located at a side wall of the light projecting portion 22 to project the light outwards in a parallel fashion. Aside from the two types of the light emitting grooves 231, the cross section of the light emitting groove 231 perpendicular to the extending direction of the light guide element 21 can also be formed in a polygonal, semicircular or irregular shape. With the light emitting groove 231 formed on the transparent zone 23, the light can be condensed and projected outwards. The location of the light emitting groove 231 can be changed to mate different types of keyboards, and light projecting direction is not restricted by the three dimensional structure of the light projecting portion 22.

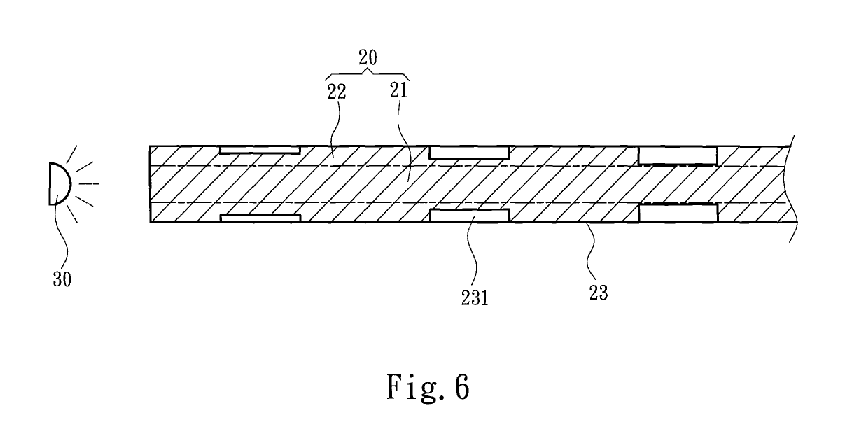

Furthermore, as the luminosity of light tends to be attenuated during transmission because of absorption or scattering, in order to avoid significant luminosity difference occurring between the location close to the external light source 30 and the location remote from the external light source 30, the depth of the light emitting groove 231 can be designed to increase gradually from the location close to the external light source 30 to the location remote from the external light source 30 as shown in FIG. 6. Thus, the light emitting groove 231 with a smaller depth has a smaller light condensing area, while the greater depth has a greater light condensing area to offset the luminosity difference caused by different light transmission distances.

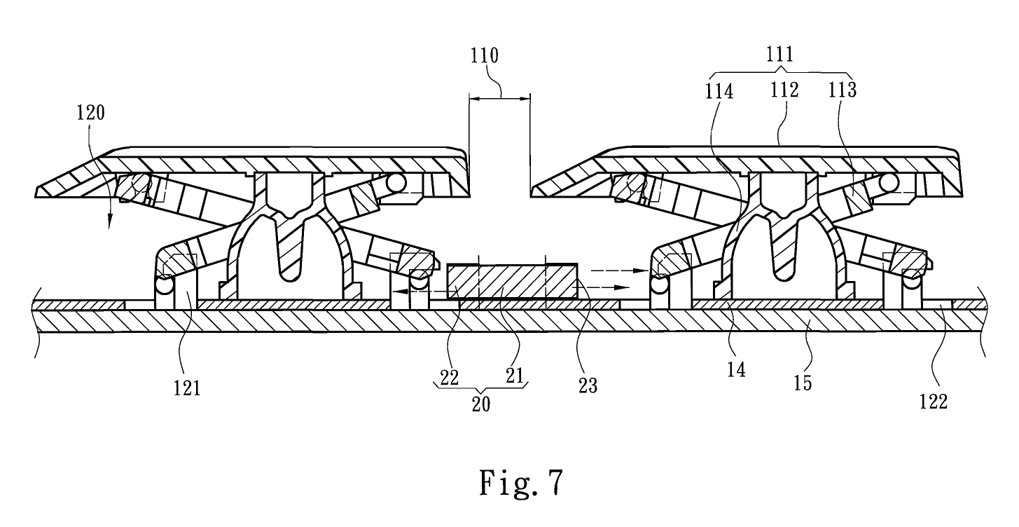

At present, there are generally two types of keyboards, one is shown in FIGS. 2 through 4 with the light guide element 20 located above the substrate 12 and the circuit board 14 below the substrate 12. A baseboard 15 further is provided below the circuit board 14 to provide support thereof. FIG. 7 illustrates a fourth embodiment in which the light guide element 20 is located above the circuit board 14, while the substrate 12 is located below the circuit board 14 to provide support thereof. Thus the baseboard 15 can be omitted to make the keyboard thinner. Other elements are arranged same as the first embodiment, thus detail are omitted.

As a conclusion, the invention provides the light guide element between any two neighboring key unit assemblies that has a light guide portion located in the horizontal mounting space and two light projecting portions located in the vertical projection space. Each light projecting portion has at least one transparent zone to condense and project light to the key unit assembly and an opaque zone outside the transparent zone. The key unit assembly includes a plurality of key units arranged in a row. Light transmitted by the light guide portion is projected through the transparent zone into the vertical projection space to provide uniform luminosity for the key unit assembly.

Moreover, the transparent zone can further include at least one light emitting groove to condense light, and the light projecting direction from the light emitting groove also can be changed by altering the three dimensional structure thereof. Compared with the conventional illuminated keyboards, the illuminated keyboard of the invention employs the light guide element of a simpler structure to achieve uniform luminosity at a greater area. In addition, the light guide element can have multiple light emitting grooves to condense and project light to the key units, thus is achieved uniform luminosity at greater intensity of the illuminated keyboard. It provides significant improvements over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An illuminated keyboard providing high and uniform luminosity, comprising:
a keyboard portion including a plurality of key units and a substrate to hold the plurality of key units for performing trigger movement, the key units being arranged in parallel rows to form a plurality of key unit assemblies, each of the plurality of key unit assemblies being spaced from the substrate to form a vertical projection space, any two neighboring key unit assemblies forming a horizontal mounting space; and
at least one light guide element which is located on the substrate and between any two neighboring key unit assemblies and includes a light guide portion located in the horizontal mounting space and two light projecting portions located in the vertical projection space, each of the two light projecting portions including at least one transparent zone to project light to one key unit assembly such that the light transmitted from the light guide portion projects via the transparent zone into the vertical projection space to provide uniform luminosity for the key unit assembly.

2. The illuminated keyboard of claim 1, wherein the light guide element includes an opaque zone on the surface of the light projecting portion outside the transparent zone.

3. The illuminated keyboard of claim 1, wherein the light guide element includes at least one end to receive the light from an external light source and guide the light into the light guide element.

4. The illuminated keyboard of claim 3, wherein the external light source is an electroluminescent element.

5. The illuminated keyboard of claim 3, wherein the external light source is a light emitting diode.

6. The illuminated keyboard of claim 3, wherein the external light source is located on the substrate.

7. The illuminated keyboard of claim 1, wherein the transparent zone includes a plurality of light emitting grooves corresponding to the key units, the light transmitted by the light guide portion being condensed by the plurality of light emitting grooves and projected to the key units.

8. The illuminated keyboard of claim 7, wherein each of the light emitting grooves is formed at a depth gradually increasing from a location proximate to the external light source to a location remote from the external light source.

9. The illuminated keyboard of claim 7, wherein each of the light emitting grooves is formed in a polygonal or semicircular cross section.

10. The illuminated keyboard of claim 7, wherein each of the light emitting grooves is formed in an irregular cross section.

11. The illuminated keyboard of claim 1, wherein each of the key units includes a keycap, a driven mechanism located between the keycap and the substrate and an elastic element located in the driven mechanism, the elastic element providing a returning force for the keycap to allow the key unit to perform the trigger movement against the substrate.

12. The illuminated keyboard of claim 11, wherein the substrate includes at least one holding portion to hold the driven mechanism.

13. The illuminated keyboard of claim 11, wherein the keyboard portion includes a circuit board located between the substrate and the keycap to generate an output command during the trigger movement of the keycap.

14. The illuminated keyboard of claim 13, wherein the circuit board is located above the substrate.

15. The illuminated keyboard of claim 13, wherein the circuit board is located below the substrate and located above a baseboard.

16. The illuminated keyboard of claim 13, wherein the light guide element is located on the circuit board.

17. The illuminated keyboard of claim 1, wherein the light guide element is located on the substrate.
